(19) United States
(12) Patent Application Publication
(10) Pub. No.: US 2016/0110734 A1
(43) Pub. Date: Apr. 21, 2016

(54) DETERMINING DEMAND OF A COMPANY

(71) Applicant: HEWLETT-PACKARD DEVELOPMENT COMPANY, L.P., Houston, TX (US)

(72) Inventors: Pranjal Mallick, Los Altos, CA (US); Vikash Kumar Sharma, Bangalore (IN)

(21) Appl. No.: 14/891,266

(22) PCT Filed: May 20, 2013
(86) PCT No.: PCT/US13/41879

§ 371 Date: Nov. 13, 2015

(51) Int. Cl. G06Q 30/02

(52) U.S. Cl. CPC G06Q 30/0202

(57) ABSTRACT

Techniques for determining a demand of a company within a country for an industry are described herein. The techniques may include determining, via processor of a computing device, a market size for the industry within a country. The techniques may include determining, via the processor, a demand for the company within the industry based on factors. The factors may include an employee value indicating the number of employees of the company. The factors may include a company revenue value indicating a revenue of the company. The factors may include a provided revenue value indicating the revenue provided to a user based on a relationship between the user and the company.

### BACKGROUND

Enterprises may engage in marketing activities to sell products or services to customers. In order make decisions regarding how and where to focus marketing efforts, an enterprise may review market information indicating the demand for any given product or service in an industry in a country. The enterprise may attempt to determine the revenue opportunity, such as the total addressable market (TAM), to analyze the potential demand or opportunity to generate revenue via sales of a given product or service to a company within an industry in a country.

### BRIEF DESCRIPTION OF DRAWINGS

Certain examples are described in the following detailed description and in reference to the drawings, in which:

FIG. 1 is a block diagram of a computing system configured to determine a demand of a company within a country for an industry;

FIG. 2 is a block diagram of the databases in communication with the market estimation engine;

FIG. 3 is a diagram illustrating the determination of integrated market size;

FIG. 4 illustrates the ranges of the company level demand;

FIG. 5 illustrates a unified range of the company level demand;

FIG. 6 is a block diagram illustrating a method for determining the demand in a company within a country for an industry; and

FIG. 7 is a block diagram illustrating a method for determining the integrated market size for the industry and a country.

### DETAILED DESCRIPTION

The subject matter disclosed herein relates to determining the demand of a company within a country and an industry. The company may be a customer of a user of the system described below. The user may have an interest in selling products or services to the company. Company-level opportunity indicating the company's potential demand to buy a product or service of the user may be helpful in effectively allocating marketing resources. The techniques described herein relate to determining the integrated market size of an industry within a country based on data that lacks both these granularities and determining company-level demand estimate within a given industry and a given country.

An “industry,” as referred to herein, is a vertical market within an industry, trade, profession, or other group of customers with specialized needs. A vertical market is a market in which vendors offer good and services to address specialized needs of the industry. Vertical markets are focused on a single niche, such as creating payroll software for start-up Internet companies, for example.

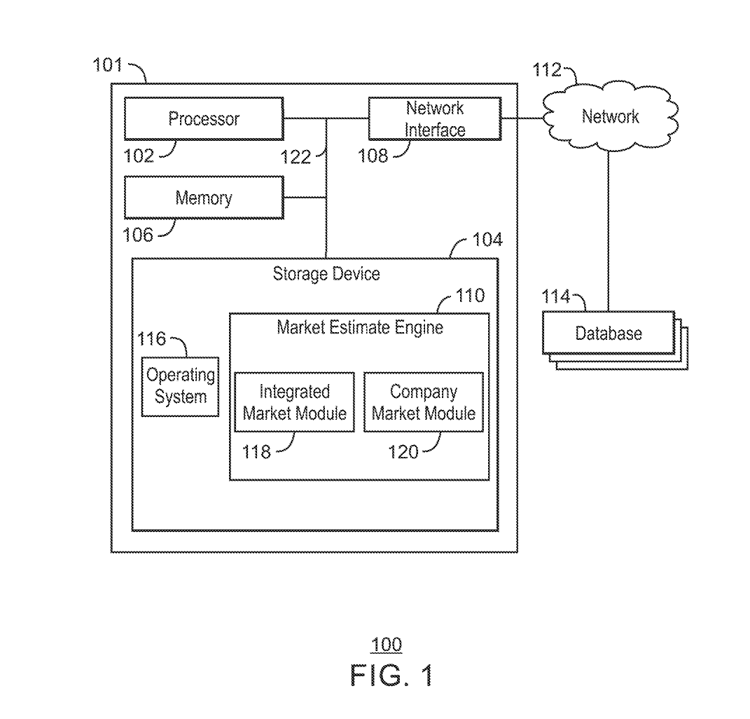

FIG. 1 is a block diagram of a computing system configured to determine a demand of a company within a country and an industry. The computing system 100 may include a computing device 101 a processor 102, a storage device 104 comprising a non-transitory computer-readable medium, a memory device 106, a network interface 108. The computing device 101 may communicate, via the network interface 108, with a network 112 to access one or more external databases 114.

The storage device 104 may include an operating system 116. The operating system 116 may be executed by a processor of a host computing system such as the processor 102 of the computing device 101. The storage device 104 may include a market estimation engine 110. The market estimation engine 110 may be a set of instructions stored on the storage device 104. The instructions, when executed by the processor 102, cause the computing device 101 to perform operations. The instructions may include code to direct the processor 102 to determine a market size for an industry within a country. The instructions may include code to direct the processor 102 to determine a demand for a company within an industry.

As indicated by FIG. 1, the market estimation engine 110 may include modules including an integrated market module 118 and company market module 120. The integrated market module 118 may be a set of instructions related to determining the market size for the industry within the country, while the company market module 120 may be a set of instructions related to determining the demand for the company within the industry.

The processor 102 may be a main processor that is adapted to execute the stored instructions. The processor 102 may be a single core processor, a multi-core processor, a computing cluster, or any number of other configurations. The processor 102 may be implemented as Complex Instruction Set Computer (CISC) or Reduced Instruction Set Computer (RISC) processors, x86 Instruction set compatible processors, multi-core, or any other microprocessor or central processing unit (CPU).

The memory device 106 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. The main processor 102 may be connected through a system bus 122 (e.g., PCI, ISA, PCI-Express, HyperTransport®, NuBus, etc.) to the network interface 108. The network interface 108 may enable the computing device 101 to communicate, via the network 112, with the one or more databases 114. In some examples, the databases 114 may include third party vendor databases storing data related to market size for an industry in a country cluster including multiple countries, market size for a country, a gross domestic product of a country, and the like. In other examples, the databases 114 may be internal data of a business or user of the system 100 and may include data indicating a past revenue that has been generated for the user based on previous sales to a company from the user.

Although FIG. 1 illustrates the databases 114 as external to the computing device 101, one or more of the databases 114 may be stored in the computing device 101 via the storage device 104. In either example, the databases 114 may store market data discussed in more detail below. The market data may be received by the market estimation engine 110 and may be used to determine company level demand as discussed in more detail below.

The block diagram of FIG. 1 is not intended to indicate that the computing device 101 is to include all of the components shown in FIG. 1. Further, the computing device 101 may include any number of additional components not shown in FIG. 1, depending on the details of the specific implementation.

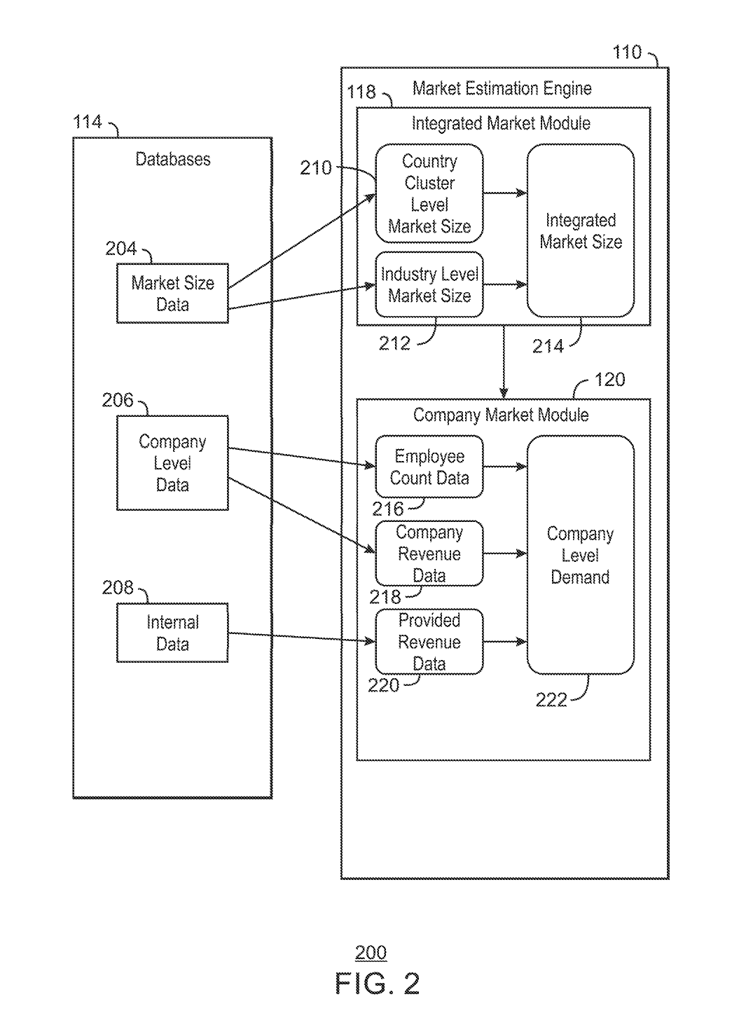

FIG. 2 is a block diagram of the databases in communication with the market estimation engine. The databases 114 are configured to provide various data to the market estimation engine 110. As illustrated in FIG. 2, the databases 114 may store market size data 204, company level data 206, and internal data 208, and the like.

Market size data 204 may include data indicating a market size for countries or industries but not both together. For instance, the market size data may indicate that the demand, or market, for France across multiple industries is 100 million dollars. The market size data 204 may also include a country cluster level industry market size indicating the demand associated within one industry across the country cluster that includes a plurality of countries. For example, the market size for an automobile industry may be 50 million dollars within Europe, wherein Europe may include a plurality of countries such as France, Spain, Italy, and the like.

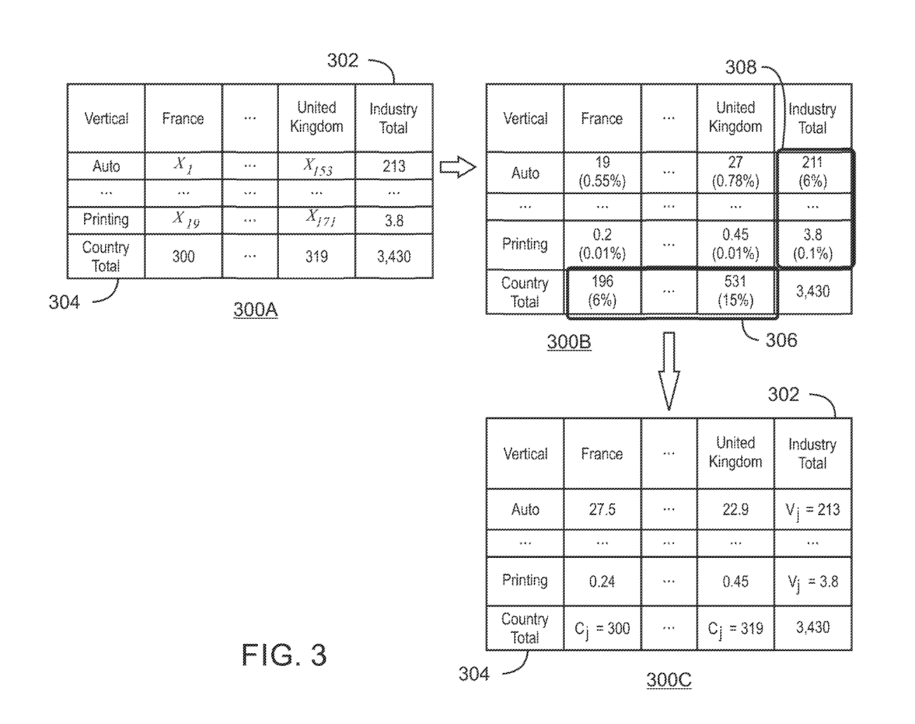

A “country,” as referred to herein, is a region identified as an entity in political geography. A country may be an independent sovereign state or one that is occupied by another state, as a non-sovereign or formerly sovereign political division, or a geographic region associated with sets of previously independent or differently associated peoples with distinct political characteristics. In some examples, a country may be a group of countries within a country cluster. In this example, the country cluster contains more than one group of countries within a country cluster. For example, a country cluster may be identified as Europe wherein the United Kingdom Islands are a group of countries including the United Kingdom, Ireland, Scotland, and the like. In either example, a country includes a region having an identifiable GPD, or similar metric, to enable granulated data to be derived as discussed in more detail below in reference to FIG. 3.

A “country cluster,” as referred to herein, is a geo-political area including a plurality of countries. For example, a country cluster may include Europe, North America, South America, Asian Pacific, etc., wherein each of the regions contains a plurality of sovereign countries. In some examples, a country cluster is defined by the sources of country cluster data. The sources of the country cluster data may include enterprises that monitor country cluster data such as the total demand of a country at a horizontal market level. Therefore, the third party may define what qualifies as a country based on internal guidelines of the third party. In some examples, a country cluster is defined by an administrator of a system, such as the computing system 100 of FIG. 1.

Company level data 206 may include the number of employees employed by a company, historical revenue generated by the company, and the like. Company level data 206 may include firmographic data. Firmographic data, as referred to herein, is data indicating quantifiable statistics of an organization. For example, firmographic data may include number of locations, location of headquarters, and the like.

Internal data 208 may include a provided revenue value. A provided revenue value, as referred to herein, is revenue provided to the user of the system 100 of FIG. 1 based on a relationship between the user and the company. In other words, provided revenue is the amount of revenue generated for the user by previous transactions between the user and the company. In some examples, company level data indicating provided revenue may be received from databases accessible by the user, or by an administrator of the system 100.

As illustrated by FIG. 2, market size data 204 may be provided to the integrated market module 118. The integrated market module 118 may receive market size data 204 including country cluster level market size 210 and industry market size 212 and may determine the market size for the industry within the country. In some examples, market size data 204 may include gross domestic product data and the integrated market module 118 may receive gross domestic product data for a given country. Further, the company market module 120 may receive company level data 206 including employee count data 216 and company revenue data 218. The company market module 120 may receive internal data 208 including provided revenue data 218. Based on the employee count data 216, the company revenue data 218, and the provided revenue data 220 the company market module 120 may determine the company level demand 220. The determinations of integrated market size 214 and company level demand 222 are discussed in more detail below in reference to FIGS. 3-5.

FIG. 3 is a diagram illustrating determining an integrated market size. As discussed above, the integrated market size is determined based on country cluster market size indicating the market size of a plurality of countries in an industry and country-level market size for a plurality of industries. The country cluster level market size for an industry is indicated by values in the column labeled “Industry Total” and indicated by the arrow 302 in tables 300A and 300C. The Industry Total column 302 is an aggregate value, and the sum of the variables xᵢ listed in each industry row should add up to the values in the Industry Total column 302. The country market size data is indicated by the values in the row labeled “Country Total,” and is indicated by the arrow 304. The Country Total row 304 is an aggregate value of variables xᵢ for a country column.

As illustrated in FIG. 3, the table 300A indicates a variable xᵢ where i is a whole number ranging over the total number of country and industry combinations. The variable xᵢ is the market size of a given industry within a given country and is to be determined. For example, as illustrated in table 300A, the variable x₁ indicates the market size of France in the automobile industry.

Initially, the xᵢ's are allocated by splitting the industry totals based on a ratio of one countries' gross domestic product (GDP) for the corresponding industry to the aggregate value of the GDP's for the same industry of all countries listed in the table. As illustrated in table 300B, the value of x₁ equals 19 million based on a GDP ratio of France's GDP for the Automotive industry to an aggregate value of the GDPs' of the Automotive industry of all the countries listed in the table 300B. However, market size for a product or services is not necessarily proportional to the GDPs' and hence do not match the country totals listed in the columns 302 and 304 of table 300A, respectively, as illustrated by the box 306 and the box 308. For example, the sum of the variables xᵢ in the column for France in table 300A is 300. However, the sum of the variables in table 300B, wherein the xᵢ's have been allocated based on a GDP ratio, is 196. Therefore, the GDP ratio allocation is minimized to ensure that the values in column 302 and the values in row 304 remain unchanged.

In some examples, a different macroeconomic factor other than GDP is used to determine an integrated market size for a country and industry combination. For example, rather than GDP a wholesale price index (WPI) or an industrial production index (IPI), or any combination thereof may be used.

As illustrated in table 300C of FIG. 3, the values of each xᵢ are adjusted so that the values in the Industry Total column 302 are the same in both table 300A and 300C. Likewise, the values of each xᵢ are adjusted so that the values in the Total Per Country row 304 are the same both table 300A and 300C. The adjustment may be a provided via a minimizing function shown in Equation 1:

$${min}_{X} f ( X ) = {\sum }_{i = 1}^{m \times n} {( \frac{{x}_{i} - {g}_{i}}{{g}_{i}} )}^{2} \qquad Eq . 1$$

In Equation 1, the variable xᵢ is the value to be determined indicating the market size for an industry and country combination. The variable gᵢ is the corresponding estimate as obtained using the country and industry GDP proportions as shown in table 300B. The variables m and n are the number of industries and number of country clusters, respectively. Equation 1 is subject to the limitations discussed below with respect to Equations 2 and 3:

$$\begin{matrix}{\sum }_{i = 1 + ( j - 1 ) \times m}^{m \times j} {x}_{i} = {c}_{i} , & Eq . 2 \\ {\sum }_{i = 1}^{n} {x}_{j + m \times ( i - 1 )} = {v}_{j} , & Eq . 3\end{matrix}$$

In equations 2 and 3, cᵢ (i=1, 2, . . . n) is the variable denoting the country market size as shown in row 304 of table 300A and 300C. The variable vⱼ (j=1, 2, . . . m) is the industry market size as shown in column 302 of tables 300A and 300C.

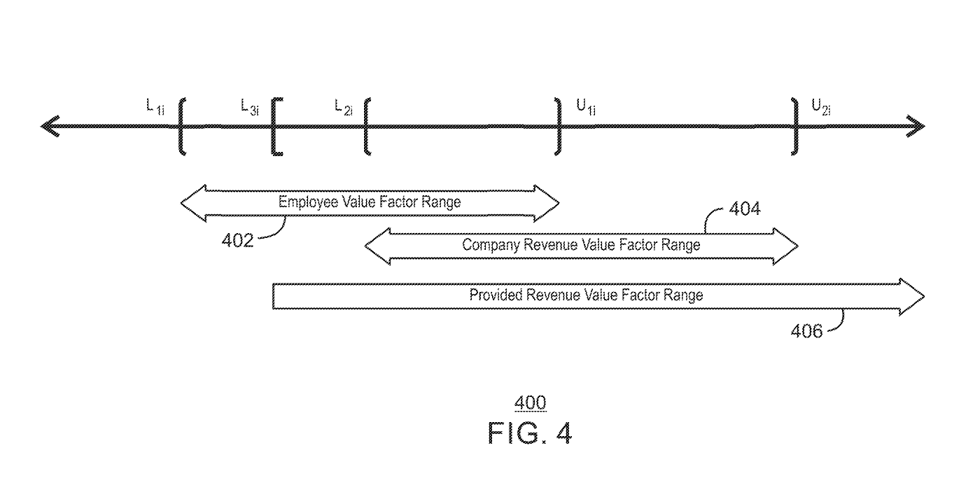

In some examples, the system of equations including Equation 1 having the limitations of Equation 2 and Equation 3 may be solved by various numerical algorithms. For example, the system of equations including Equations 1-3 may be solved by a first order derivative based algorithm such as a Conjugate Gradient Method algorithm. The system of equations including Equations 1-3 may also be solved via a second order derivative based algorithm such as a Trust Region Method algorithm. The solution of the system of Equations 1-3 provides an integrated market size wherein the market size for an industry and a country is determined. As discussed in more detail below in reference to FIG. 4, the integrated market size may be used to determine a company level demand within an industry and country combination.

The company level demand for a company within an industry and country combination is based on multiple factors. The factors include an employee value indicating the number of employees of the company. The factors may also include a company revenue value indicating a revenue of the company. The factors may also include a provided revenue value indicating a revenue provided to a user based on a relationship between the user and the company. In some examples, various other factors may be used depending on business justifications. The values of each factor may be stored in a database, such as one of the databases 114 of FIGS. 1 and 2. Further, as discussed above in reference to FIG. 1 and FIG. 2, the company market module 120 may determine the company level demand 222 based on the data received by the databases 114.

The company level demand is a range of demand values comprising a maximum demand value and a minimum demand value. The range of the company level demand is determined based on ranges associated with the factors discussed above. Thus, the company level demand may be a range based on the employee value factor, a range based on the company revenue value factor, or a range based on the provided revenue value factor. The range based on the employee value factor is illustrated in Equation 4:

$$( ( 1 - α ) \times \frac{M}{E} ) \times {e}_{i} \leq {y}_{i} \leq ( ( 1 + α ) \times \frac{M}{E} ) \times {e}_{i} \qquad Eq . 4$$

In Equation 4, α is a variation constant that lies between 0 and 1, eᵢ is the number of employees in the company, M is the market size of the corresponding industry and country combination as obtained from solving Equations 1-3, E is the total number of employees in all the companies within that industry and country combination, and yᵢ is the company level demand to be estimated. In Equation 4, yᵢ—the company level demand—has a lower bound, l₁ᵢ, and upper bound, u₁ᵢ, wherein l₁ᵢ≦yᵢ≦u₁ᵢ.

The range based on the company revenue value factor is illustrated in Equation 5:

$$( ( 1 - α ) \times \frac{M}{R} ) \times {r}_{i} \leq {y}_{i} \leq ( ( 1 + α ) \times \frac{M}{R} ) \times {r}_{i} \qquad Eq . 5$$

In Equation 5, α is a variation constant that lies between 0 and 1, rᵢ is the revenue of the company, M is the market size of the corresponding industry and country combination as obtained from solving Equations 1-3, R is total revenue of all the companies within the same industry and country combination, and yᵢ is the company level demand. In Equation 5, yᵢ—the company level demand—has a lower bound, l₂ᵢ, and upper bound, u₂ᵢ, i.e., l₂ᵢ≦yᵢ≦u₂ᵢ.

The range based on the provided revenue value factor is illustrated in Equation 6:

$$\frac{{s}_{i}}{β} \leq {y}_{i} i . e . \qquad Eq . 6$$

In Equation 6, sᵢ is the revenue provided to the user based on the relationship of the user and the company. In other words, sᵢ is the revenue generated based on products and services that have been sold to company by the user. Equation 6 includes β which is a ratio indicating a predetermined maximum that is intended to limit the possible company level demand. In this assumption, the ratio may be predetermined by a user or an administrator of a system, such as the system 100 discussed in FIG. 1. In Equation 6, yᵢ is the company level demand that has a lower bound, l₃ᵢ, and no upper bound l₃ᵢ≦yᵢ<∞ and i=1, 2, . . . , k, where k denotes the number of companies in a particular industry and country combination.

FIG. 4 illustrates the ranges of the company level demand. For example, the double block arrow 402 represents the employee value factor range, the double block arrow 404 represents the company revenue value factor range, and the single block arrow 406 indicates the provided revenue value factor range.

The company level demand is based on a unified range derived by combining the ranges associated with the factors discussed above. The unified range has as a maximum demand value that is the lowest maximum of any range, and wherein the unified range has a minimum demand value that is the highest minimum of any range.

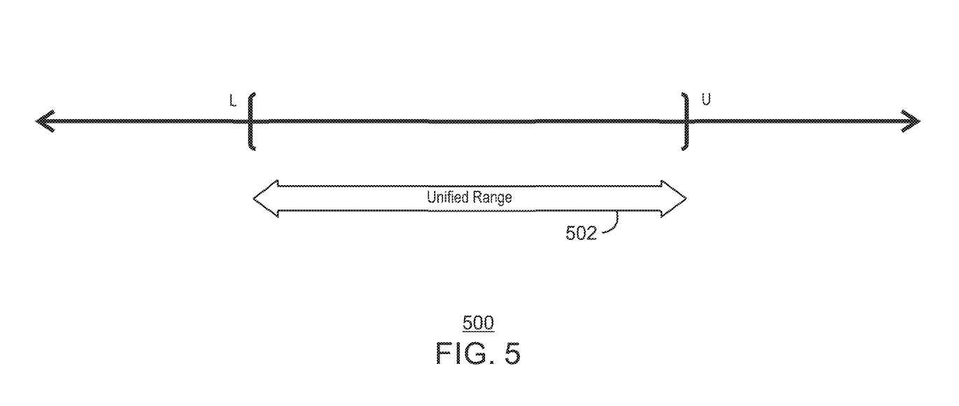

FIG. 5 illustrates a unified range of the company level demand. The unified range 502 is defined by Equations 7 and 8:

L_{unified}=max(l₁ᵢ, l₂ᵢ, l₃ᵢ) Eq. 7

In Equation 7, L_{unified} is the lower bound of the unified range and is equal to the maximum lower bound of the employee value factor range 402, the company revenue value factor range 404, and the provided revenue value factor range 406 discussed above in reference to FIG. 4.

U_{unified}=min(u₁ᵢ,u₂ᵢ) Eq. 8

In Equation 8, U_{unified} is the upper bound of the unified range and is equal to the minimum upper bound of the employee value factor range 402 and the company revenue factor range 404.

In some examples, the administrator of a system, such as the system 100 of FIG. 1, may set a global lower bound (l_{admin}) and a global upper bound (u_{admin}) in order to keep the estimated company level demand within realistic bounds as determined by the administrator. If L_{unified} is less than l_{admin} then it is reset to l_{admin}. Similarly if U_{unified} is greater than u_{admin} then it is reset to u_{admin}.

The unified range 502 includes any overlap occurring between all of the ranges 402, 404, and 406 discussed above in reference to FIG. 4. However, in some examples, the ranges 402, 404, and 406 may not have overlap occurring in all of the ranges. When the ranges 402, 404, 406 do not have overlap occurring in all of the ranges, the unified range may be defined by Equations 9 and 10:

L_{unified}=max(mean(l₁ᵢ,l₂ᵢ,l_{admin})) Eq. 9

In Equation 9, L_{unified} is lower bound of the unified range and is equal to the maximum of the mean of the lower bounds of the employee value factor range 402, the company revenue factor range 404, the provided revenue value range 406 discussed above in reference to FIG. 4, and the lower bound provided by an administrator of the system. Equation 10 provides:

U_{unified}=min(mean(u₁ᵢ,u₂ᵢ,u_{admin})) Eq. 10

In Equation 10, U_{unified} is upper bound of the unified range and is equal to the minimum of the mean of the upper bounds of the employee value factor range 402, the company revenue factor range 404, the provided revenue value range 406 discussed above in reference to FIG. 4, and the upper bound provided by an administrator of the system. Therefore, even when the ranges 402, 404, and 406 do not have common overlap, a unified range estimating the company level demand may be determined.

The company level demand determined in view of the Equations 4-10 above, may be formulated as a quadratic optimization as shown in Equation 11:

$${min}_{y} f ( y ) = {( {\sum }_{i = 1}^{k} {y}_{i} - M )}^{2} \qquad Eq . 11$$

In Equation 11, yᵢ is the company level demand and M is the total market size of the corresponding industry and country combination as obtained by solving Equations 1-3. Further, yᵢ is subject to the upper and lower bounds discussed above such that lᵢ≦yᵢ≦uᵢ. The system of equations including Equations 4-11 may be solved by either a first order or a second order derivative based algorithm including Quasi-Newton Raphson method, the Trust Region method, and the like.

Estimating the company level demand may be scaled and reproduced to do the same for a plurality of different companies in a given industry and country combination. Further, the system discussed above quantitatively expresses the company level demand and may inform decisions made by users of the system in regard to marketing efforts.

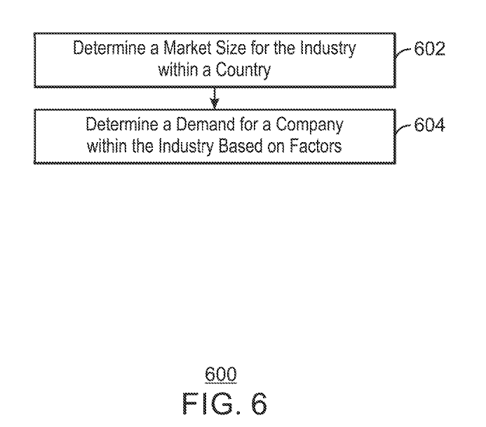

FIG. 6 is a block diagram illustrating a method for determining the demand in a company within a country and an industry. At block 602, the market size for an industry and a country combination is determined. At block 604, the demand for a company within an industry and a country is determined based on factors. The factors may include an employee value indicating the number of employees of the company; a company revenue value indicating a revenue of the company; and a provided revenue value indicating a revenue provided to a user based on a relationship between the user and the company.

The demand in a company based on any one factor is a range of values comprising a maximum demand value and a minimum demand value. Therefore, the method 600 may include determining a range based on the employee value factor, determining a range based on the company revenue value factor, determining a range based on the provided revenue value factor, and determining a unified range. The unified range is a range that has as a maximum demand value that is the lowest maximum of any range. The unified range is also a range that has a minimum demand value that is the highest minimum of any range.

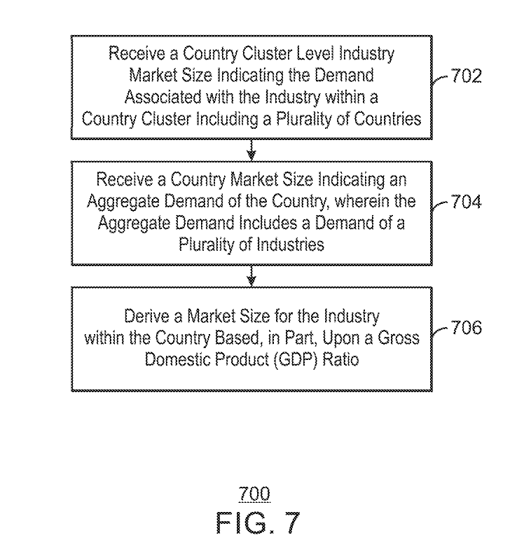

FIG. 7 is a block diagram illustrating a method for determining the market size for an industry and a country combination. The method 700 may be carried about by a processor of a computing system, such as the processor 102 of the system 100. At block 702, a country cluster level industry market size indicating the demand associated with the industry within a country cluster comprising a plurality of countries is received. For example, the country cluster level industry market size may be data received by a module from a database, such as the integrated market module 118 and the databases 114 of FIG. 1. At block 704, a country market size indicating an aggregate demand of the country, wherein the aggregate demand comprises a demand of a plurality of industries is received. At block 706, a market size for the industry within the country is computed based, in part, upon a gross domestic product (GDP) ratio. The GDP ratio is a proportion of one countries' gross domestic product (GDP) for the corresponding industry to the aggregate value of the GDP's for the same industry of all countries within a country cluster. For example, the market size for the industry and a country combination may be computed by the integrated market module 118 of FIG. 1.

In some examples, the method 700 illustrated in FIG. 7 may include minimizing the computed market size based on the GDP ratio such that the country cluster level industry market size and the country market size each remain unchanged. The computed market size based on the GDP ratio may not accurately reflect the actual market size. Therefore, the allocation of market size is minimized such that the country cluster industry market size and the country market size values remain unchanged.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A method of determining a demand of a company, comprising:
determining, via a processor of a computing device, a market size for an industry within a country; and
determining, via the processor, the demand for the company within the industry based on factors comprising:
an employee value indicating the number of employees of the company;
a company revenue value indicating a revenue of the company; and
a provided revenue value indicating a revenue provided to a user based on a relationship between the user and the company.

2. The method of claim 1, wherein determining the market size for the industry within the country comprises:
receiving a country cluster level industry market size indicating the demand associated with the industry within a country cluster comprising a plurality of countries;
receiving a country market size indicating an aggregate demand of the country, wherein the aggregate demand comprises a demand of a plurality of industries; and
deriving a market size for the industry within the country based, in part, upon a gross domestic product (GDP) ratio, wherein the GDP ratio indicates a proportion of a gross domestic product of the country to a gross domestic product of another country of the country cluster.

3. The method of claim 2, comprising, minimizing the derived market size based on the GDP ratio such that the country cluster level industry market size and the country market size each remain unchanged.

4. The method of claim 1, wherein the demand for the company based on any one factor is a range of demand values comprising a maximum demand value and a minimum demand value.

5. The method of claim 4, wherein determining the demand for the company comprises:
determining a range based on the employee value factor;
determining a range based on the company revenue value factor;
determining a range based on the provided revenue value factor; and
determining a unified range, wherein the unified range has as a maximum demand value that is the lowest maximum of any range, and wherein the unified range has a minimum demand value that is the highest minimum of any range.

6. A system for determining a demand of a company, the system comprising:
a processor; and
a memory device that stores computer-readable instructions that, when executed by the processor, direct the processor to:
determine a market size for the industry within the country; and
determine a demand for the company within the industry based on factors comprising:
an employee value indicating the number of employees of the company;
a company revenue value indicating a revenue of the company; and
a provided revenue value indicating a revenue provided to a user based on a relationship between the user and the company.

7. The system of claim 6, wherein the code to direct the processing unit to determine a market size for the industry within the country comprises code to direct the processor to:
receive a country cluster level industry market size indicating the demand associated with the industry within a country cluster comprising a plurality of countries;
receive a country market size indicating an aggregate demand of the country, wherein the aggregate demand comprises a demand of a plurality of industries; and
derive a market size for the industry within the country based, in part, upon a gross domestic product (GDP) ratio, wherein the GDP ratio indicates a proportion of a gross domestic product of the country to a gross domestic product of another country of the country cluster.

8. The system of claim 7, wherein the code to derive a market size for the industry within the country comprises code to direct the processor to minimize the derived market size based on the GDP ratio such that the country cluster level industry market size and the country market size each remain unchanged.

9. The system of claim 6, wherein the demand for the company based on any one factor is a range of demand values comprising a maximum demand value and a minimum demand value.

10. The system of claim 9, wherein the code to direct the processing unit to determine a demand for the company within the industry based on the factors comprises code to direct the processor to:
determine a range based on the employee value factor;
determine a range based on the company revenue value factor;
determine a range based on the provided revenue value factor; and
determine a unified range, wherein the unified range has as a maximum demand value that is the lowest maximum of any range, and wherein the unified range has a minimum demand value that is the highest minimum of any range.

11. One or more non-transitory, tangible, computer-readable storage devices, comprising code configured to direct a processor to:
determine a market size for the industry within a country; and
determine a demand for the company within the industry based on factors comprising:
an employee value indicating the number of employees of the company;
a company revenue value indicating a revenue of the company; and
a provided revenue value indicating a revenue provided to a user based on a relationship between the user and the company.

12. The one or more computer-readable storage devices of claim 11, comprising code to:
receive a country cluster level industry market size indicating the demand associated with the industry within a country cluster comprising a plurality of countries;
receive a country market size indicating an aggregate demand of the country, wherein the aggregate demand comprises a demand of a plurality of industries; and
derive a market size for the industry within the country based, in part, upon a gross domestic product (GDP) ratio, wherein the GDP ratio indicates a proportion of a gross domestic product of the country to a gross domestic product of another country of the country cluster.

13. The one or more computer-readable storage devices of claim 12, comprising code to minimize the derived market size based on the GDP ratio such that the country cluster level industry market size and the country market size each remain unchanged.

14. The one or more computer-readable storage devices of claim 11, wherein the demand for the company based on any one factor is a range of demand values comprising a maximum demand value and a minimum demand value.

15. The one or more computer-readable storage devices of claim 14, wherein the code to direct the processing unit to determine a demand for the company within the industry based on the factors comprises code to direct the processor to:
determine a range based on the employee value factor;
determine a range based on the company revenue value factor;
determine a range based on the provided revenue value factor; and
determine a unified range, wherein the unified range has as a maximum demand value that is the lowest maximum of any range, and wherein the unified range has a minimum demand value that is the highest minimum of any range.
